(19) United States
(12) Patent Application Publication
(10) Pub. No.: US 2003/0015976 A1
(43) Pub. Date: Jan. 23, 2003

(54) Power device of scooter

(75) Inventor: Tsang-Ying Chen, Chang Hua Hsien (TW)

Correspondence Address: BROWDY AND NEIMARK, P.L.L.C., 624 NINTH STREET, NW, SUITE 300, WASHINGTON, DC, 20001-5303, US

(73) Assignee: J.D. COMPONENTS CO., LTD., Chang Hua Hsien (TW)

(21) Appl. No.: 09/932,997

(22) Filed: Aug. 21, 2001

(30) Foreign Application Priority Data
Jul. 19, 2001 (TW) 90212235

(51) Int. Cl. H02P 1/00; H02K 7/10

(52) U.S. Cl. 318/9

(57) ABSTRACT

A power device of the scooter comprises a motor and a unidirectional bearing. The motor is mounted in proximity of the rear wheel of the scooter and is provided with an output shaft which is connected with the axle of the rear wheel. The unidirectional bearing is disposed on the axle of the rear wheel to provide a unidirectional clutching effect enabling the rear wheel to receive the power transmission of the motor in a predetermined manner. As the motor is started, the output shaft of the motor drives the rear wheel to turn at a constant speed. As the motor is stopped, the rear wheel in motion is hauled to turn on its own.

### FIELD OF THE INVENTION

The present invention relates generally to a scooter, and more particularly to a power device of the scooter.

### BACKGROUND OF THE INVENTION

The conventional scooters are generally not provided with a power device and are moved by a series of pushes of a rider's foot against the ground. It is therefore conceivably tiresome to ride the conventional scooter for a prolonged period of time. This inventor of the present invention discloses an electric scooter. However, the electrically-driven scooter may take various forms.

### SUMMARY OF THE INVENTION

The primary objective of the present invention is to provide a scooter with a power device capable of driving the scooter at a constant speed.

The scooter of the present invention comprises a motor and a unidirectional bearing. The motor is mounted at the rear end of the scooter and is provided with an output shaft, which is connected with a rear wheel axle of the scooter. The rear wheel axle is provided with the unidirectional bearing for providing a unidirectional clutching effect, thereby enabling the rear wheel to be driven by the motor in a predetermined manner.

The rear wheel of the scooter is actuated to turn at a constant speed by the output shaft of the motor in operation. The rear wheel in motion is capable of turning on its own at the time when the motor is no longer in operation.

The scooter of the present invention further comprises a torsion adjustment device, which is fastened with the output shaft of the motor for providing a torsion of a predetermined magnitude to suit the body weight of the scooter rider.

### BRIEF DESCRIPTION OF THE DRAWINGS

FIG. 1 shows a perspective view of a preferred embodiment of the present invention.

FIG. 2 shows an enlarged view of the preferred embodiment of the present invention.

FIG. 3 shows a sectional view of the preferred embodiment of the present invention as shown in FIG. 2.

### DETAILED DESCRIPTION OF THE INVENTION

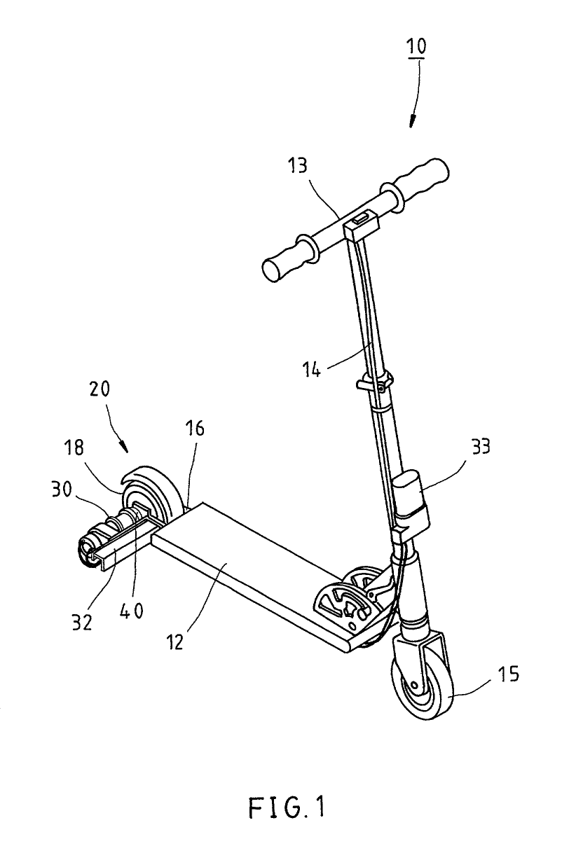

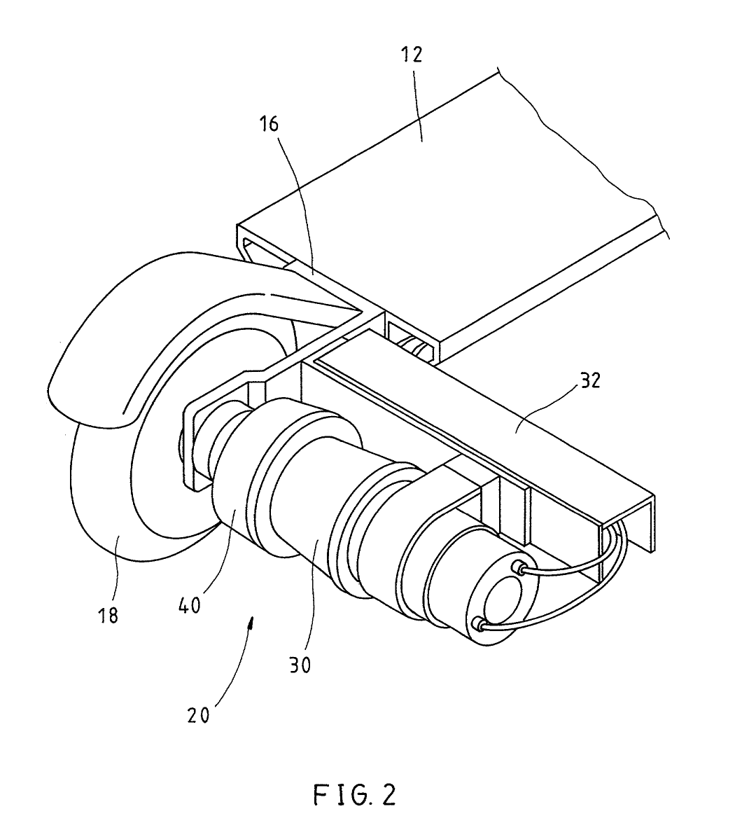

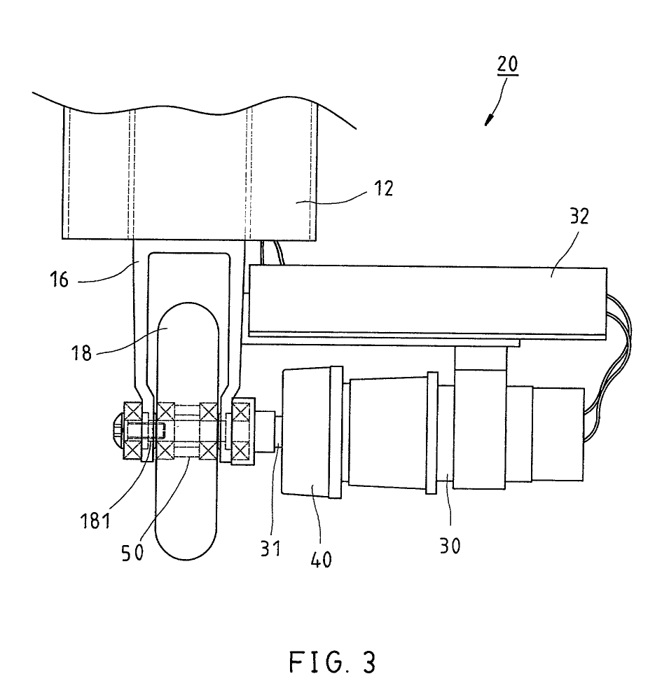

As shown in FIGS. 1-3, a power device 20 of the preferred embodiment of the present invention is mounted on a scooter 10 which is formed of a bottom board 12, a handlebar frame 13 pivoted to the front end of the bottom board 12. The handlebar frame 13 is fastened with a brake cable 14. A front wheel 15 is pivoted to the bottom end of the handlebar frame 13. A rear fork 16 is extended from the rear end of the rear fork 16. The power device 20 is mounted at the rear end of the scooter and is formed of a motor 30, a torsion adjustment device 40, and a unidirectional bearing 50, which are all prior art structures.

The motor 30 is mounted on a fixation seat 32 which is mounted at one side of the rear fork 16 such that fixation seat 32 is parallel to the axle 181 of the rear wheel 18 of the scooter 10. The motor 30 has an output shaft 31 which is coaxial with the axle 181 of the rear wheel 18. A switch 33 is mounted on the handlebar frame 13 of the scooter 10 for regulating the power of the motor 30.

The torsion adjustment device 40 is mounted on the output shaft 31 of the motor 30 and is provided with torsions of various magnitudes, thereby enabling the scooter 10 to have a variety of load capacities to suit the body weight of the scooter rider.

The unidirectional bearing 50 is mounted on the axle 181 of the rear wheel 18 for providing the scooter with a unidirectional clutching effect. The rear wheel 18 is thus enabled to receive the power transmission of the output shaft 31 of the motor 30 in a predetermined manner.

As the motor 30 is started, the unidirectional bearing 50 enables the output shaft 31 of the motor 30 to engage the axle 181 of the rear wheel 18 of the scooter 10. As a result, the rear wheel 18 of the scooter 10 is driven by the motor 30 at a constant speed. When the motor 30 is stopped, the axle 181 of the rear wheel 18 is not restrained by the output shaft 31 of the motor 30, thereby enabling the rear wheel 18 to turn freely.

The switch 33 is used to regulate the power provided by the output shaft 31 of the motor 30 such that the power is transmitted to the rear wheel 18 of the scooter 10 via the torsion adjustment device 40 and the unidirectional bearing 50, and that the power is stabilized. As the switch 33 is turned off, the scooter 10 can be operated by the foot of the rider such that the rear wheel 18 is so actuated to turn, so as to move the scooter 10 forward.

The fixation seat of the motor 30 may be mounted over the rear fork 16 of the scooter 10 such that the output shaft 31 of the motor 30 and the axle 181 of the rear wheel 18 are interconnected at an angle of 90 degrees by means of a sectoral gear. The fixation seat is not necessarily mounted in such a way that the fixation seat is coaxial with the axle 181 of the rear wheel 18, thereby downsizing the scooter in the horizontal direction but enlarging the scooter in the longitudinal direction.

The embodiment of the present invention described above is to be regarded in all respects as being merely illustrative and not restrictive. Accordingly, the present invention may be embodied in other specific forms without deviating from the spirit thereof. The present invention is therefore to be limited only by the scopes of the following claims.

What is claimed is:

1. A power device of a scooter, said power device comprising:
a motor mounted in proximity of a rear wheel of the scooter and provided with an output shaft which is connected with the axle of the rear wheel;
a unidirectional bearing disposed on the axle of the rear wheel for providing a unidirectional clutching effect enabling the rear wheel to receive the power transmission of said motor in a predetermined manner;
said output shaft of said motor in operation actuating the rear wheel of the scooter to turn at a constant speed such that the rear wheel of the scooter is hauled to turn on its own at the time when said motor is no longer in operation.

2. The power device as defined in claim 1, further comprising a torsion adjustment device which is disposed on said output shaft of said motor for providing a torsion transmission of a predetermined magnitude to suit a user's body weight.

3. The power device as defined in claim 1, wherein said motor is mounted by means of a fixation seat on one side of a rear fork of the scooter such that said output shaft of said motor is coaxial with the axle of the rear wheel of the scooter.

4. The power device as defined in claim 1, wherein said motor is mounted by means of a fixation seat over a rear fork of the scooter such that said output shaft of said motor is connected with the axle of the rear wheel of the scooter at an angle of 90 degrees.

5. The power device as defined in claim 1, wherein said motor has a switch which is mounted on a handlebar frame of the scooter for switching the power of said motor.
